(19) United States
(12) Patent Application Publication
(10) Pub. No.: US 2015/0149907 A1
(43) Pub. Date: May 28, 2015

(54) Portable Electronic Apparatus and Interface Display Method Thereof

(71) Applicant: Acer Inc., New Taipei City (TW)

(72) Inventor: Jung-Yu Wu, New Taipei City (TW)

(21) Appl. No.: 14/450,350

(22) Filed: Aug. 4, 2014

(30) Foreign Application Priority Data
Nov. 28, 2013 (TW) 102143601

(51) Int. Cl. G06F 3/16; G06F 3/0481

(52) U.S. Cl. CPC G06F 3/167; G06F 3/0481
USPC 715/728

(57) ABSTRACT

A portable electronic apparatus and an interface display method thereof are disclosed. The method includes the following steps of: executing an application; capturing and analyzing an environmental sound around the portable electronic apparatus to obtain at least one sound character;

determining a state of motion of the portable electronic apparatus; comparing the at least one sound character and the state of motion with a statistics data of the application to determine an interface display mode of the application; and locking the interface display mode as a predetermined interface display mode for displaying a display interface of the application when a compared result is obtained by the comparing step.

### BACKGROUND OF THE INVENTION

1. Field of the Invention

The invention relates to a portable electronic apparatus and an interface display method thereof, and more particularly, it relates to a portable electronic apparatus and an interface display method thereof to determine an interface display mode based on the environment of the present location and the state of motion of the apparatus.

2. Description of the Related Art

Portable electronic apparatuses can execute various applications and allow users to install any application based on their needs. Different applications support different interface display modes according to the designs, such as a landscape mode or a portrait mode. To offer the convenience of operating and viewing the portable electronic apparatus, some applications support a G-sensor or a sensor element with similar functions installed in the portable electronic apparatus. When this type of sensor detects that the orientation of the screen of the apparatus has changed, it can instruct the display interface of the application to rotate accordingly and to change the interface display mode.

However, if a user does not want to change the current interface display mode of the application, the aforementioned design may cause annoyance. For example, if the orientation of the portable electronic apparatus is changed unintentionally (such as if the apparatus is impacted or swayed to rotate due to an external force), such that the interface display mode changes while the user is holding the portable electronic apparatus to browse web pages or to execute applications, the user's operation or the execution of an application may be interrupted. At this moment, the user must rotate the portable electronic apparatus again in order to switch back to the previous interface display mode. Such unnecessary switching between the interface display modes increases the waiting time and the power consumption.

### SUMMARY OF THE INVENTION

A main objective of the present invention is to provide an interface display method that determines an interface display mode based on the environment of the present location and the state of motion of the apparatus.

To achieve the above objective, an interface display method of the present invention is applied to a portable electronic apparatus. The method comprises the following steps of: executing an application; capturing and analyzing an environmental sound around the portable electronic apparatus to obtain at least one sound character; determining a state of motion of the portable electronic apparatus; comparing the at least one sound character and the state of motion with a usage statistics data of the application to determine an interface display mode of the application; and locking the interface display mode as a predetermined interface display mode for displaying a display interface of the application when a compared result is obtained by the comparing step.

A portable electronic apparatus of the present invention comprises a control module, a sound processing module, a movement detection module, a data collection module, and a comparison module. The control module is used for executing an application. The sound processing module is used for capturing and analyzing the environmental sound around the portable electronic apparatus to obtain at least one sound character. The movement detection module is used for determining a state of motion of the portable electronic apparatus. The data collection module is used for recording a usage statistics data of the application. The comparison module is used for comparing the at least one sound character and the state of motion with the statistical data of the application to determine an interface display mode of the application and for informing the control module to lock the interface display mode as a predetermined interface display mode for displaying a display interface of the application.

Accordingly, when a user executes any application, the present invention displays and locks the interface display mode of the application based on the current conditions of the apparatus in comparison with the usage statistics data of the application. As a result, the display interface of the application will not switch automatically between different interface display modes due to rotation or swaying of the apparatus so as to avoid interruption of the user's operation and provide a better user experience.

### BRIEF DESCRIPTION OF THE DRAWINGS

FIG. 1 is a system block diagram of a portable electronic apparatus applying an interface display method of the present invention.

FIG. 2 is a flowchart of the interface display method of the present invention.

FIG. 3 is a flowchart of another embodiment of the interface display method of the present invention.

### DETAILED DESCRIPTION OF THE PREFERRED EMBODIMENT

The advantages and innovative features of the invention will become more apparent from the following detailed description when taken in conjunction with the accompanying drawings.

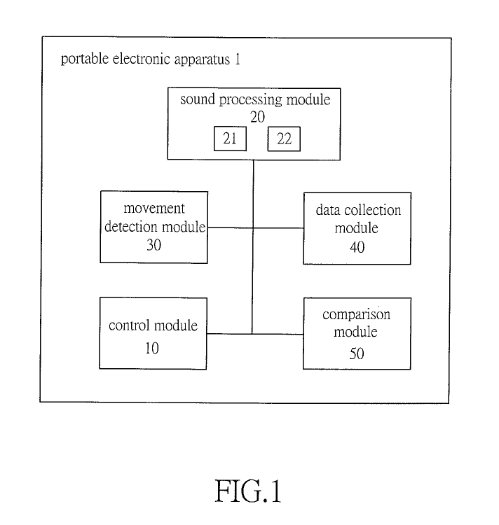

Please refer to FIG. 1 first. FIG. 1 is a system block diagram of a portable electronic apparatus 1 applying an interface display method of the present invention. In one embodiment of the present invention, the portable electronic apparatus 1 can be, but is not limited to, a smart phone, a tablet computer, or a notebook computer.

As shown in FIG. 1, the portable electronic apparatus 1 comprises a control module 10, a sound processing module 20, a movement detection module 30, a data collection module 40, and a comparison module 50. The control module 10 is used for executing an application. The control module 10 can be a main control element in the apparatus (such as a central processing unit or an operating system). The application is installed and stored in a memory or on a hard disk of the apparatus, and the application is executed by the control module 10 based on an instruction input by a user.

The sound processing module 20 comprises a sound capturing unit 21 and a sound analysis unit 22. The sound capturing unit 21 can be a microphone for capturing an environmental sound around the portable electronic apparatus 1. The sound analysis unit 22 can be a processing chip or a program which has the functions of analyzing and identifying sounds. The sound analysis unit 22 analyzes the captured environmental sound and obtains at least one sound character by voice recognition technology to determine an environment corresponding to the environmental sound.

The movement detection module 30 is used for determining a state of motion of the portable electronic apparatus 1. The movement detection module 30 can be a hardware module or program that has the function of positioning, such as modules supporting GPS, Wi-Fi positioning, or 3G positioning. The movement detection module 30 is used to determine whether the portable electronic apparatus 1 is in a moving state or in a stationary state.

The data collection module 40 is used for collecting and recording a usage statistics data of any application in advance for use as a comparison reference by the comparison module 50. The usage statistics data of the application include sound characters of the environmental sound around the apparatus while the apparatus executes the application (by means of the sound processing module 20, which captures and analyzes the environmental sound to determine the corresponding environment), the state of motion of the apparatus (by means of the movement detection module 30, which determines whether the apparatus is in a moving state or in a stationary state), and an interface display mode being utilized (in portrait mode or landscape mode). Therefore, the habitual interface display mode of executing the application under different environments and different states of motion can be statistically summarized. The data collection module 40 can be a program that can perform a data collection function or a storage module that is embedded with the program.

In one embodiment of the present invention, within a set period, the data collection module 40 can record the at least one sound character, the state of motion, and the interface display mode during each execution of the application by the control module 10 to obtain the usage statistics data of the application by statistical analysis. The set period can range from a few hours to a few days in order to collect sufficient data for the statistical analysis. However, the present invention is not limited thereto. In addition, the set period can be determined by an actual duration starting from installing the application, or can be determined by an accumulated duration of the application being executed.

In another embodiment of the present invention, within a specified number of executions of the application, the data collection module 40 can also record the at least one sound character, the state of motion, and the interface display mode during each execution of the application by the control module 10 to obtain the usage statistics data of the application by statistical analysis. Similarly, the specified number of executions can be a few times to a few dozens of times in order to collect sufficient data for the statistical analysis. However, the present invention is not limited thereto.

Each time the application is executed, the data collection module 40 starts recording the usage statistics data of the application. When the application is terminated or the application has not been used after a set amount of idle time, the data collection module 40 stops recording the statistical data of the application. The idle time can be a few dozens of seconds to a few minutes in order to collect sufficient data for statistical analysis. However, the present invention is not limited thereto.

The comparison module 50 uses the at least one sound character analyzed by the sound processing module 20 from the current environmental sound around the apparatus and the current state of motion of the apparatus detected by the movement detection module 30 to compare the usage statistics data of the application. In other words, the comparison module 50 can compare the at least one sound character analyzed by the sound processing module 20 with a plurality of sound characters in the usage statistics data of the application, and the comparison module 50 can compare the state of motion of the apparatus detected by the movement detection module 30 with a plurality of state of motion data in the statistical data of the application. Finally, based on a compared result, the comparison module 50 determines the interface display mode corresponding to the sound character and the state of motion from the usage statistics data of the application. The interface display mode can be either a landscape mode or a portrait mode, and is not limited thereto.

After the comparison module 50 determines the interface display mode of the application by the compared result, the comparison module 50 then informs the control module 10 to lock the interface display mode as a predetermined interface display mode for displaying a display interface of the application while executing the application. The comparison module 50 can be a hardware module or a program that has a data comparison function.

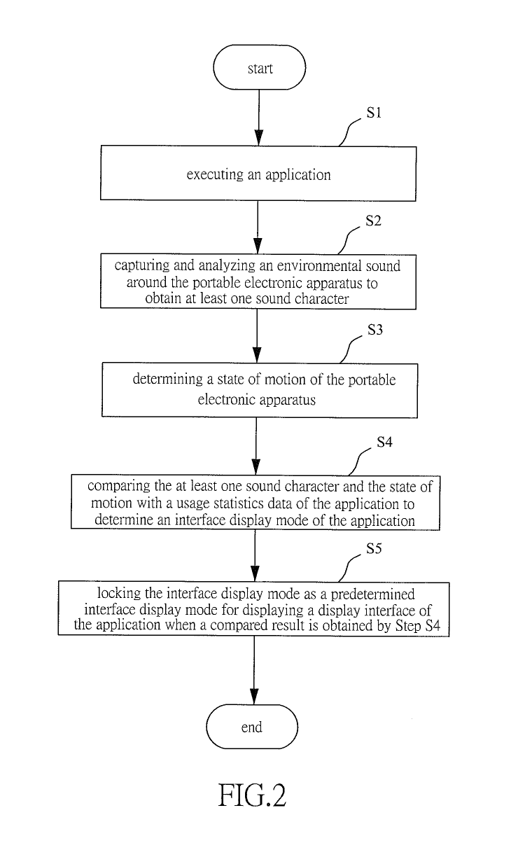

Please refer to FIG. 2. FIG. 2 is a flowchart of the interface display method of the present invention. It is noted that although the present invention illustrates the interface display method with the portable electronic apparatus 1 shown in FIG. 1, the present invention can be applied to any other portable electronic apparatus having a similar structure or function. As shown in FIG. 2, the interface display method of the present invention comprises step S1 to step S5. Detailed explanations of each step are provided below.

Step S1: executing an application.

First, the portable electronic apparatus 1 can receive a command input by the user to execute an application. For example, the application is executed by the user touching an icon of the application.

Step S2: capturing and analyzing an environmental sound around the portable electronic apparatus 1 to obtain at least one sound character.

When the application is executed, the sound capturing unit 21 of the sound processing module 20 starts capturing an environmental sound around the portable electronic apparatus 1 and transmits the captured environmental sound to the sound analysis unit 22 to be analyzed and identified so as to obtain at least one sound character from the environmental sound.

Step S3: determining a state of motion of the portable electronic apparatus.

Similarly, when the application is executed, the movement detection module 30 also starts determining a state of motion of the portable electronic apparatus 1. According to whether the position of the apparatus is changed or not, the movement detection module 30 can determine whether the portable electronic apparatus 1 is in a moving state or in a stationary state.

Step S4: comparing the at least one sound character and the state of motion with the usage statistics data of the application to determine an interface display mode of the application.

After the at least one sound character of the environmental sound is obtained by Step S2 and the state of motion of the portable electronic apparatus 1 is determined by Step S3, the comparison module 50 can compare the at least one sound character and the state of motion with the usage statistics data of the application previously collected so as to identify the interface display mode in accordance with the current operating environment and the state of motion of the portable electronic apparatus 1. Then the comparison module 50 informs the control module 10 of the results.

Step S5: locking the interface display mode as a predetermined interface display mode for displaying a display interface of the application when a compared result is obtained by Step S4.

After determining the interface display mode in accordance with the current operating environment and the state of motion of the portable electronic apparatus 1 by Step S4, the control module 10 locks the determined interface display mode as a predetermined interface display mode for displaying a display interface of the application when a compared result is obtained by Step S4. Therefore, the display interface of the application can continuously remain in the predetermined interface display mode. The interface display mode will not be switched even if the user changes the position of the portable electronic apparatus 1.

Please refer to Table 1, which contains examples of the usage statistics data collected for different applications respectively.

TABLE 1

| Usage | Application | | | |
|---|---|---|---|---|
| Behavior | Browser | Browser | Line | Google Maps |
| Environment | Meeting | On a Bus | In a Subway | On a Street |
| | Occasion | | Train | |
| State of motion | Stationary | Moving | Moving | Moving |
| Predetermined | Landscape | Portrait | Portrait | Landscape |
| Interface Display | Mode | Mode | Mode | Mode |
| Mode | | | | |

As shown in Table 1, it is assumed that the data collection module 40 collects respectively the usage statistics data of different applications in advance, such as a browser, Line, and Google Maps. The environment is inferred from the obtained sound characters obtained from analysis of the environmental sound around the apparatus by the sound processing module 20. For example, if the sound processing module 20 analyzes the environmental sound to obtain the sound characters of station names being announced, it can infer that the apparatus is located in a moving subway train or a moving bus. Again, for example, if the sound processing module 20 analyzes the environmental sound to obtain the sound characters of horns and sounds of moving vehicles, it can infer that the apparatus is located on a street. By means of the movement detection module 30, whether the apparatus is in a moving state or in a stationary state can be detected according to whether the position of the apparatus is changed or not. The interface display mode thus displays the predetermined display interface of the application in the portrait mode or in the landscape mode while executing the application.

Consider the program Line as an example. According to the usage statistics data of the applications in Table 1, when the user executes Line on the portable electronic apparatus while riding a moving subway train, the portrait mode is usually chosen to view the display interface of Line. The portrait mode is set as the predetermined interface display mode. Therefore, by means of the design of the present invention, once the user executes Line on a moving subway train, and the current conditions of the portable electronic apparatus are matched with the usage statistics data of Line, the control module 10 can lock the portrait mode for displaying the display interface of Line. At this time, even if the user rotates or sways the apparatus, the portrait mode for displaying the display interface of Line will not be changed. If the application is a browser, according to the different current conditions of the apparatus, the interface display mode for displaying the display interface of the browser will be locked in the portrait mode or in the landscape mode with reference to Table 1.

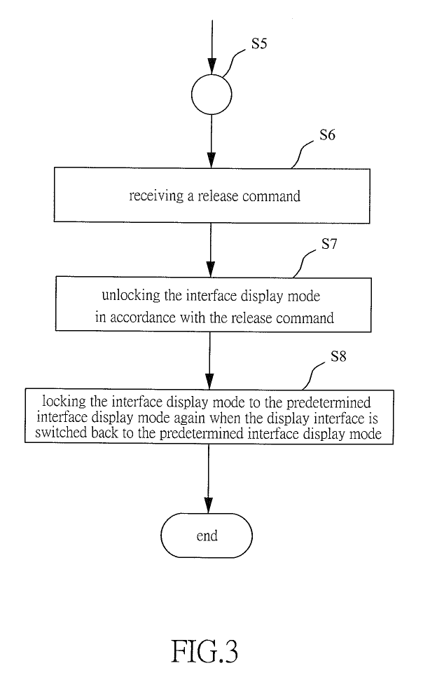

Please refer to FIG. 1 and FIG. 3 together. FIG. 3 is a flowchart of another embodiment of the interface display method of the present invention. As shown in FIG. 3, the interface display method of the present invention further comprises Step S6 to Step S8. Detailed explanations of each additional step are provided below.

Step S6: receiving a release command.

When the interface display mode is locked, if the user wishes to change the current interface display mode of the application, the user can input a release command and the control module 10 will receive the release command. The release command can be generated by touch gesture input by the user (for example, the user taps the screen of the apparatus twice consecutively) or by pressing of the physical or soft keys of the apparatus. However, the present invention is not limited thereto.

Step S7: unlocking the interface display mode in accordance with the release command.

After the control module 10 receives the release command, the control module 10 unlocks the interface display mode of the application in accordance with the release command to return to the normal state. At this time, the user can rotate or move the apparatus to switch between the different interface display modes of the application.

In addition, the present invention further comprises Step S8: locking the interface display mode to the predetermined interface display mode again when the display interface is switched back to the predetermined interface display mode.

Sometimes, the user may wish to unlock the locked interface display mode temporarily. Therefore, after the interface display mode is unlocked, if the control module 10 determines that the interface display mode for displaying the display interface of the application has been switched to a different interface display mode and then switched back afterward, the control module 10 will lock the interface display mode to the predetermined interface display mode again to resume the lock mechanism of the predetermined interface display mode of the present invention.

Accordingly, the user can execute any application of the portable electronic apparatus. The interface display method compares the environment where the apparatus is located and the state of motion with the usage statistics data of the application so as to lock the interface display mode corresponding to the application. Thus, the interface display mode will not be switched due to the rotation or swaying of the apparatus, and interruption of the user operation can be avoided.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An interface display method, applied to a portable electronic apparatus, which comprises the following steps of:
executing an application;
capturing and analyzing an environmental sound around the portable electronic apparatus to obtain at least one sound character;
determining a state of motion of the portable electronic apparatus;
comparing the at least one sound character and the state of motion with a usage statistics data of the application to determine an interface display mode of the application; and
locking the interface display mode as a predetermined interface display mode for displaying a display interface of the application when a compared result is obtained by the comparing step.

2. The interface display method as claimed in claim 1, wherein the usage statistics data is a statistical data recording the at least one sound character, the state of motion, and the interface display mode during each execution of the application within a set period.

3. The interface display method as claimed in claim 1, wherein the usage statistics data is a statistical data recording the at least one sound character, the state of motion, and the interface display mode during each execution of the application within a specified number of executions of the application.

4. The interface display method as claimed in claim 2, wherein recording of the usage statistics data is begun each time the application is executed, and recording of the usage statistics data is stopped when the application is terminated or the application has not been used after a set amount of idle time.

5. The interface display method as claimed in claim 3, wherein recording of the usage statistics data is begun each time the application is executed, and recording of the usage statistics data is stopped when the application is terminated or the application has not been used after a set amount of idle time.

6. The interface display method as claimed in claim 1, further comprising the following steps of:
receiving a release command;
unlocking the interface display mode in accordance with the release command; and
locking the interface display mode to the predetermined interface display mode again when the display interface is switched back to the predetermined interface display mode.

7. A portable electronic apparatus, comprising:
a control module used for executing an application;
a sound processing module used for capturing and analyzing an environmental sound around the portable electronic apparatus to obtain at least one sound character;
a movement detection module used for determining a state of motion of the portable electronic apparatus;
a data collection module used for recording a usage statistics data of the application; and
a comparison module used for comparing the at least one sound character and the state of motion with the usage statistics data of the application to determine an interface display mode of the application and for informing the control module to lock the interface display mode as a predetermined interface display mode for displaying a display interface of the application.

8. The portable electronic apparatus as claimed in claim 7, wherein the usage statistics data is a statistical data recording the at least one sound character, the state of motion, and the interface display mode recorded by the data collection module during each execution of the application by the control module within a set period.

9. The portable electronic apparatus as claimed in claim 7, wherein the usage statistics data is a statistical data recording the at least one sound character, the state of motion, and the interface display mode recorded by the data collection module during each execution of the application by the control module within a specified number of executions.

10. The portable electronic apparatus as claimed in claim 8, wherein the data collection module starts recording the usage statistics data each time the application is executed, and the data collection module stops recording the statistical data when the application is terminated or the application has not been used after a set amount of idle time.

11. The portable electronic apparatus as claimed in claim 9, wherein the data collection module starts recording the usage statistics data each time the application is executed, and the data collection module stops recording the statistical data when the application is terminated or the application has not been used after a set amount of idle time.

12. The portable electronic apparatus as claimed in claim 6, wherein when the control module receives a release command, the control module unlocks the interface display mode in accordance with the release command, and the control module locks the interface display mode to the predetermined interface display mode again when the display interface is switched back to the predetermined interface display mode.
